(19) United States
(12) Patent Application Publication
(10) Pub. No.: US 2026/0358892 A1
(43) Pub. Date: Nov. 12, 2026

(54) TOUCHSCREEN MOUNTING SYSTEM AND HAPTIC USER INTERFACE

(71) Applicant: NEXTEQ PLC, Balsham, Cambridgeshire (GB)

(72) Inventor: Bazile PETER, Cambridge, Cambridgeshire (GB)

(73) Assignee: NEXTEQ PLC, Balsham, Cambridgeshire, GB (GB)

(21) Appl. No.: 19/515,643

(22) PCT Filed: Sep. 4, 2024
(86) PCT No.: PCT/GB2024/052296

§ 371 Date: Mar. 2, 2026

(30) Foreign Application Priority Data
Sep. 4, 2023 (GB) 2313467.9

(51) Int. Cl. G06F 3/01

(52) U.S. Cl. CPC G06F 3/016

(57) ABSTRACT

A touchscreen mounting system and haptic user interface using the touchscreen mounting system are disclosed. The touchscreen mounting system includes a base and a plurality of separate z-springs. Each of the plurality of separate z-springs has a mounting surface mounted to the base and has a connection surface that at least partially overlaps the z-spring's mounting surface, is substantially co-planar to the connection surface of other z-springs and is configured to receive and support the touchscreen, whereby each of the z-springs is interposed between a mounted touchscreen and the base and provides sprung resistance to the mounted touchscreen in a direction perpendicular to its connection surface and also in a direction non perpendicular to its connection surface. The orientation of at least two of the plurality of z-springs differs whereby the at least two of the plurality of z-springs at least partially oppose each other's movement other than in the direction perpendicular to the connection surface.

### FIELD OF THE INVENTION

The present invention relates to a touchscreen mounting system and in particular to a touchscreen display mounting system for supporting haptic feedback.

### BACKGROUND TO THE INVENTION

Touchscreen display devices such as those in which a touchscreen overlays an LCD or similar display are an increasingly popular way of providing user interfaces. They may provide input mechanisms such as virtual buttons, keyboards, dials and the like. In some cases they may also accommodate physical knobs and the like which are combined with the touchscreen to communicate, interact, show information around or within the physical control etc. In addition to graphical feedback provided by the display onto which the touchscreen is overlayed, it is common for touchscreen devices to provide tactile feedback of some form, often referred to as haptic feedback, for example to mimic the forces that may be felt when a physical control is actuated. Haptic feedback can be implemented in a number of ways. Most common among these is vibration of the complete product (such as in the case of mobile phones) however this does not work for a product which is permanently attached to larger enclosure which does not move.

Touchscreens are popular because they provide a flexible, intuitive, and adaptable input/output mechanism and yet have few mechanical parts and so are easy to keep clean and operational under all environmental conditions. An example use of a touchscreen display is in a kiosk or other public facing user input system in which a touchscreen panel is mounted within the kiosk or other enclosure and used to provide the user interface to functionality of the kiosk etc.

It will be appreciated that in order for the touchscreen display to vibrate, it must have sufficient freedom of movement so that the vibrations are not dampened by the device, enclosure or the like in which the touchscreen is mounted. It is desirable that the mount does not substantially dampen the vibrations of the haptic actuator(s) yet provides a sufficiently rigid mount that the touchscreen does not feel as if it is flexing or moving when the user is interacting with it. Touchscreens vary in size and weight although those used in mounted arrangements such as these tend to be towards the larger form factors (A5 and larger) which present greater challenges to generate an adequate haptic response whilst also ensuring the touchscreen display assembly is adequately attached to the enclosure into which it is installed. It is desirable that a mounting system can mount and support the weight of such larger form factor touchscreens while maintaining the ability to use haptic feedback.

### STATEMENT OF INVENTION

According to an aspect of the present invention, there is provided a touchscreen mounting system comprising a base and a plurality of separate z-springs, each of the plurality of separate z-springs having a mounting surface mounted to the base and having a connection surface that at least partially overlaps the z-spring's mounting surface, is substantially co-planar to the connection surface of other z-springs and is configured to receive and support the touchscreen, whereby each of the z-springs is interposed between a mounted touchscreen and the base and provides sprung resistance to the mounted touchscreen in a direction perpendicular to its connection surface and also in a direction non perpendicular to its connection surface, the orientation of at least two of the plurality of z-springs differs whereby the at least two of the plurality of z-springs at least partially oppose each other's movement other than in the direction perpendicular to the connection surface.

The base may be a frame, body of a device or system or other supporting structure to which the touchscreen (also referred to as the touchscreen module) is to be mounted via the z-springs.

Preferably the z-springs are of the same dimensions and positioned about the base so as to provide multiple support sites to the touchscreen. Preferably the connection surface of the z-springs are substantially co-planar (or at least in planes parallel to one another). Preferably, one or more of the z-springs are rotated about an axis perpendicular to the connection surface such that the z-springs provide sprung resistance in a plane of, or parallel to, the connection surfaces and the varying rotation of the z-springs counter-act the sprung resistance of each other that would otherwise be present in a non-perpendicular direction.

Z-springs differ from many other springs (helical springs, for example) in that they offer sprung resistance in one plane while having fixed resistance with no sprung movement in at least one perpendicular plane. In embodiments of the present invention, multiple separate z-springs in varying orientation (rotated with respect to one another) are used to restrict the number of perpendicular planes having no sprung movement.

Preferably, the z-springs have a predetermined spring constant and a haptic actuator that is mounted on the touchscreen or integrated within the touchscreen can be used with the z-springs to develop a resonant frequency, determined in dependence on the predetermined spring constant, which produces a relatively large haptic output with small energy input. In such an arrangement, the actuator cost and current consumed is minimised. This is of significant benefit when trying to move large masses, such as a large display (ie. larger than a Smartphone display).

The z-springs are interposed between the base and the touchscreen, providing sprung resistance and sprung support to the touchscreen in a z direction towards the base and substantially fixed support to the touchscreen in the x and y directions which, typically, are parallel to the plane of the user interface surface of the touchscreen (and that of the base).

Preferably, the z-springs are freely positionable on the base so as to accommodate different base types and different touchscreen modules. The z-springs are preferably secured to the base and touchscreen module by use of an adhesive glue.

By selectively orienting the Z-Springs, the inventors achieved enhanced stability and improved haptic response for the touchscreen module. The materials, dimensions and configuration of the Z-Springs were selected to provide stability, durability, and accurate expansion in perpendicular movement. Placement of the Z-Springs and the actuator onto the touchscreen module also was found to impact the haptic response as adjacent Z-Springs may dampen each other. Therefore freedom of positioning enables the positioning to be tuned for best placement dependent on available fixing surfaces offered by the base and touchscreen module.

Preferably, when a touch event is initiated, a signal passes through a touch driver to the main microprocessor. Subsequently, an event is generated and sent to the haptic microcontroller, which then activates the actuator. Preferably, this entire process occurs within a very short timeframe, ranging from 15 ms to 50 ms. If the process exceeds this timeframe, the person touching the screen may not perceive or associate the haptic response with the touch event. Preferably, multiple linear resonant actuators (LRAs) are used as the actuators. Maintaining parallel activation of the LRAs, without any delays between activation of each actuator, was found to provide the best haptic response. Failure to maintain parallel activation may result in the haptic response being nullified between different areas of the touch screen, ultimately resulting in no haptic feedback.

By using more than one Z-spring, motion can be restricted to predominantly one axis, which:
a. constrains the haptic vibration to occur, predominantly, in only one axis, thereby maximising the haptic energy output to that axis
b. helps to support a large mass, such as a large display, in all axes other than the axis of movement and vibration, so allowing this mass to be mounted with limited other supporting features

By using at least two Z springs that are each rotated about the z-axis so as to have different x-y orientations, it is possible to set up a haptic system that is supported in all axes, other than the axis of movement and vibration (the z-axis), so allowing the display to be mounted without other supporting features.

### BRIEF DESCRIPTION OF THE DRAWINGS

Embodiments of the present invention will now be described by was of example only with reference to the accompanying drawings in which:

FIG. 1 is a sectional view of a touchscreen mounting system according to an embodiment;

FIG. 2 is an illustration showing the embodiment of FIG. 1 in operation;

FIG. 3 is a plan view of a touchscreen mounting system according to another embodiment;

FIGS. 4a and 4b are perspective and exploded schematic views of a touchscreen incorporating a mounting system according to an embodiment; and,

FIG. 5 illustrates dimensions of a z-springs suitable for use in an embodiment.

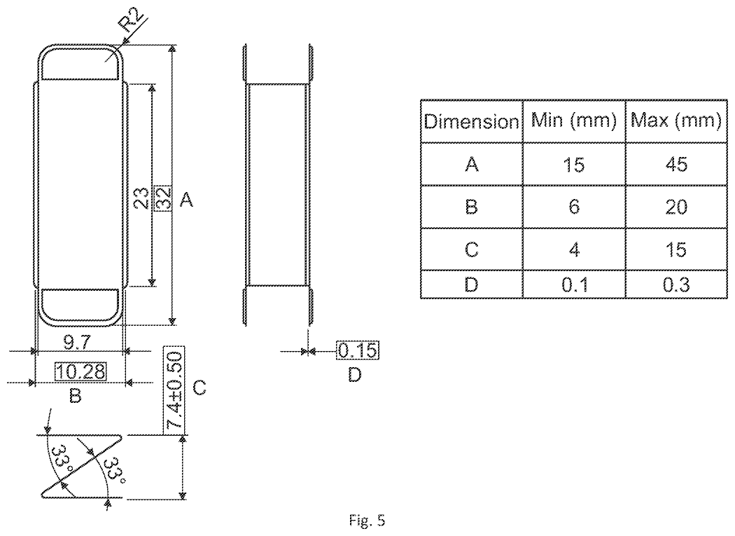

### DETAILED DESCRIPTION

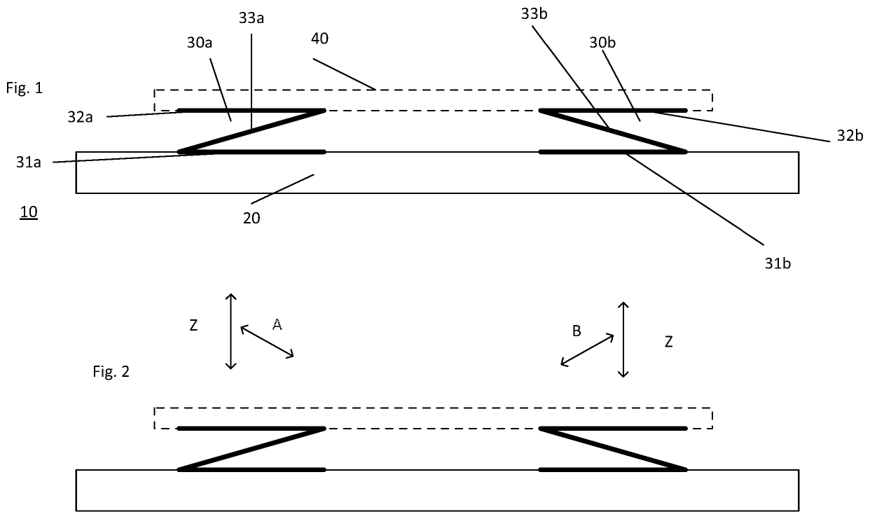

FIG. 1 is a sectional view of a touchscreen mounting system according to an embodiment.

The touchscreen mounting system 10 comprising a base 20 and a plurality of separate z-springs 30a 30b. Each of the plurality of separate z-springs 30a, 30b has a mounting surface 31a, 31b mounted to the base 20 and having a connection surface 32a, 32b that at least partially overlaps the respective z-spring's mounting surface 30a, 30b and is substantially co-planar to the connection surface of other z-springs. A lateral surface 33a, 33b connects the mounting surface 31a, 31b to the respective connection surface 32a, 32b. The connection surfaces 32a, 32b are configured to receive and support the touchscreen 40 such that the z-springs are interposed between the base 20 and the touchscreen 40. Preferably, the z-springs are formed as a single piece. Preferably, the z-springs are formed by folding or otherwise forming metal or plastics.

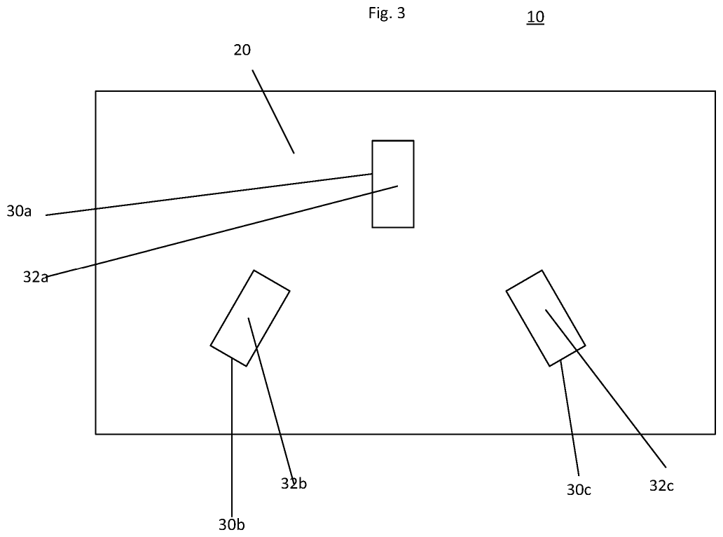

As shown in FIG. 2, Each of the z-springs 30a, 30b provides sprung resistance to a mounted touchscreen in a direction Z perpendicular to its connection surface 32a, 32b and also in a direction (labelled A and B for the respective springs) non perpendicular to its connection surface 32a, 32b.

The plurality of z-springs 30a, 30b are mounted on the base 20 by their respective mounting surfaces 31a, 31b. The orientation of at least two of the plurality of z-springs differs such that they at least partially oppose each other's movement other than in the direction Z perpendicular to the connection surface. As a result, movement in direction A or B is resisted.

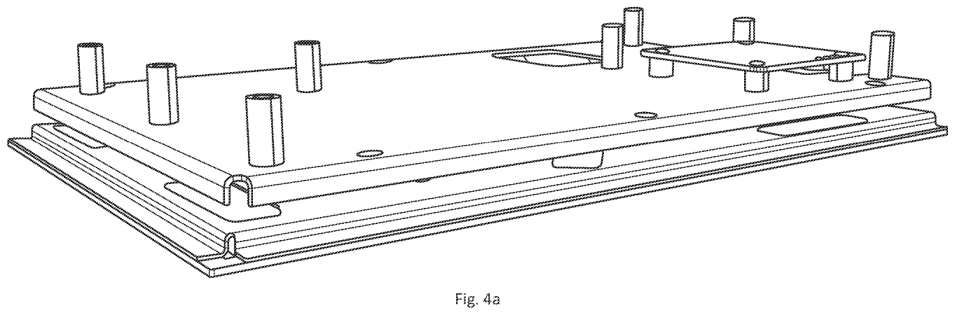

FIG. 3 is a plan view of a touchscreen mounting system according to another embodiment.

In this embodiment, there are three z-springs 30a, 30b, 30c which provide support to a touchscreen (not shown) via their respective connection surfaces 31a, 31b, 31c. They have differing x-y orientations on the base 20 so that movement in the non-perpendicular direction by one of the springs is resisted by the other two springs. Haptic force by an actuator on or in the touchscreen is therefore constrained to the perpendicular z direction and the energy needed to generate the haptic stimulus is minimized.

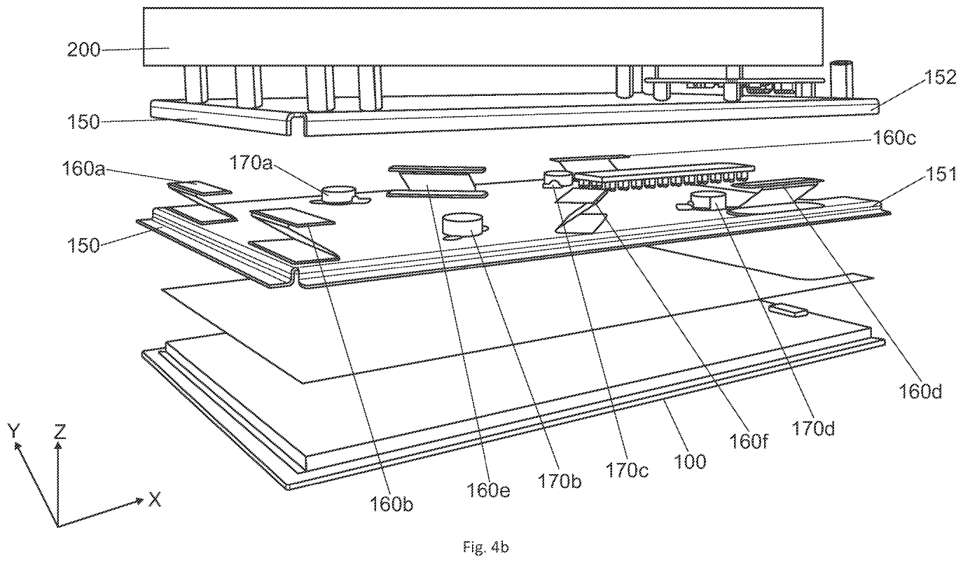

FIGS. 4a and 4b are, respectively, a perspective schematic view and an exploded schematic view of a haptic touchscreen display system according to an embodiment. The display system in this embodiment uses a TFT touchscreen display panel 100 mounted via a frame 150 to a mount 200. The mount might, for example, be part of a kiosk, a vehicle dashboard, a stand or some other mount.

In this embodiment, multiple z-springs 160a-160f and LRA actuators 170a-170d are mounted within the frame 150. Preferably, the frame includes first and second panels 151, 152, the LRA actuators 170a-170d being mounted to the first panel 151 and the z-springs 160a-160f connecting the first and second panels 151, 152 and being sandwiched between them.

In this preferred embodiment, a first z-spring 160a is oriented at approx. 90° to a second z-spring 160c and a third z-spring 160e is oriented at approx. 45°. Preferably pairs of z-springs 160a, 160b; 160c, 160d and 160e, 160f are employed. Preferably the third z-spring pair 160 e, 160f are positioned at opposite 45° orientations as shown in FIG. 4b. Although 4 LRA actuators and 6 z-springs are shown, other numbers are possible. In this embodiment, the LRA actuators are positioned in two rows, the two rows being spaced substantially equidistantly along the length of the first panel.

It was identified that placement of all the Z-Spring in one orientation had less haptic response and less stability. Having the Z-Springs in multi directional orientations improved stability and haptic response. Placing the LRAs in positions between the Z-springs was also found to contribute to better haptic response.

It is preferred that actuation of the LRAs be synchronized by the controller or controllers so as to produce the optimal haptic response. It may also be possible to create a haptic wave or similar progressing across the device and the LRAs from one side to another.

It was found that z-springs formed by folding 0.14 mm 302 or 304 HR Stainless steel were particularly suited to this application, although other materials and thicknesses may be usable. Preferably, the major angle between the connection and mounting surfaces of the z-spring and the lateral surface 33a, 33b is approximately 33°. Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention.

1. A touchscreen mounting system comprising a base and a plurality of separate z-springs, each of the plurality of separate z-springs having a mounting surface mounted to the base and having a connection surface that at least partially overlaps the z-spring's mounting surface, is substantially co-planar to the connection surface of other z-springs and is configured to receive and support the touchscreen, whereby each of the z-springs is interposed between a mounted touchscreen and the base and provides sprung resistance to the mounted touchscreen in a direction perpendicular to its connection surface and also in a direction non perpendicular to its connection surface, the orientation of at least two of the plurality of z-springs differs whereby the at least two of the plurality of z-springs at least partially oppose each other's movement other than in the direction perpendicular to the connection surface.

2. The touchscreen mounting system of claim 1, wherein the z-springs are of the same dimensions and positioned about the base so as to provide multiple support sites to the touchscreen.

3. The touchscreen mounting system of claim 1, wherein the connection surfaces of the z-springs are substantially co-planar.

4. The touchscreen mounting system of claim 1, wherein one or more of the z-springs are rotated about an axis perpendicular to the connection surface such that the z-springs provide sprung resistance in a plane of, or parallel to, the connection surfaces.

5. The touchscreen mounting system of claim 4, wherein the rotation of the z-springs is varied relative to other z-springs of the mounting system.

6. The touchscreen mounting system of claim 1, wherein the z-springs have a predetermined spring constant selected to develop a resonant frequency when subject to a predetermined haptic signal from a haptic signal source.

7. The touchscreen mounting system of claim 1, wherein each of the z-springs is freely positionable on the base.

8. A haptic user interface comprising a touchscreen mounted to a touchscreen mounting system comprising a base and a plurality of separate z-springs, each of the plurality of separate z-springs having a mounting surface mounted to the base and having a connection surface that at least partially overlaps the z-spring's mounting surface, is substantially co-planar to the connection surface of other z-springs and is configured to receive and support the touchscreen, whereby each of the z-springs is interposed between a mounted touchscreen and the base and provides sprung resistance to the mounted touchscreen in a direction perpendicular to its connection surface and also in a direction non perpendicular to its connection surface, the orientation of at least two of the plurality of z-springs differs whereby the at least two of the plurality of z-springs at least partially oppose each other's movement other than in the direction perpendicular to the connection surface, the haptic mounting system further comprising one or more haptic actuators mounted proximate to the z-springs and configured to create a resonant frequency through the z-springs when the actuator is operated.

9. The haptic user interface of claim 8, wherein the z-springs are of the same dimensions and positioned about the base so as to provide multiple support sites to the touchscreen.

10. The haptic user interface of claim 8, wherein the connection surfaces of the z-springs are substantially co-planar.

11. The haptic user interface of claim 8, wherein one or more of the z-springs are rotated about an axis perpendicular to the connection surface such that the z-springs provide sprung resistance in a plane of, or parallel to, the connection surfaces.

12. The haptic user interface of claim 11, wherein the rotation of the z-springs is varied relative to other z-springs of the mounting system.

13. The haptic user interface of claim 8, wherein the z-springs have a predetermined spring constant selected to develop a resonant frequency when subject to a predetermined haptic signal from a haptic signal source.

14. The haptic user interface of claim 8, wherein each of the z-springs is freely positionable on the base.
